(19) United States
(12) Patent Application Publication
(10) Pub. No.: US 2024/0168835 A1
(43) Pub. Date: May 23, 2024

(54) HARD DISK FAILURE PREDICTION METHOD, SYSTEM, DEVICE AND MEDIUM

(71) Applicant: Army Academy of Armored Forces, Beijing (CN)

(72) Inventors: Yujiang Wang, Beijing (CN); Shicheng Wei, Beijing (CN); Yi Liang, Beijing (CN); Bo Wang, Beijing (CN); Wei Xin, Beijing (CN); Fangjie Lu, Beijing (CN); Chao Zheng, Beijing (CN)

(21) Appl. No.: 18/517,076

(22) Filed: Nov. 22, 2023

(30) Foreign Application Priority Data
Nov. 23, 2022 (CN) 202211470140.6

(51) Int. Cl. G06F 11/00

(52) U.S. Cl. CPC G06F 11/008

(57) ABSTRACT

A hard disk failure prediction method, a hard disk failure prediction system, a device and a medium are provided. The method includes: acquiring SMART attribute values of a hard disk; performing data standardization processing on the SMART attribute values, and filtering the processed SMART attribute values to obtain filtered SMART attribute values; constructing a hard disk failure prediction key database according to the filtered SMART attribute values, a warning value and a rating value corresponding to the filtered SMART attribute values; optimizing a decision tree-based hard disk failure prediction model by using the hard disk failure prediction key database to obtain an optimized decision tree-based hard disk failure prediction model; and acquiring SMART attribute values of a target hard disk hard disk, and predicting a health of the target hard disk to obtain a prediction result. The present disclosure improves the accuracy of failure prediction.

### CROSS-REFERENCE TO RELATED APPLICATION

This patent application claims the benefit and priority of Chinese Patent Application No. 202211470140.6 filed with the China National Intellectual Property Administration on Nov. 23, 2022, the disclosure of which is incorporated by reference herein in its entirety as part of the present application.

### TECHNICAL FIELD

The present disclosure relates to the field of hard disk failure prediction, in particular to a hard disk failure prediction method, a hard disk failure prediction system, a device and a medium.

### BACKGROUND

Nowadays, hard disks have been widely used. In practical application, different hard disks have different usage methods, which lead to frequent hard disk failures, and the failures may result in serious data loss. However, if a method of predicting the service life of a hard disk may be proposed, a technical guarantee to nip in the bud may be provided to customers.

In order to obtain good failure prediction results, scholars use the Self-Monitoring Analysis and Reporting Technology (SMART) data and an artificial intelligence algorithm to perform the failure prediction, and use the binary classification, the health and the remaining service life to measure the health status of hard disks. The prediction methods are all based on the SMART technology embedded in a hard disk device, but the SMART technology is not perfect. The accuracy of the failure prediction provided by the SMART technology is only about 30%.

For example, in the prior art, there are a method and an apparatus for dynamically diagnosing hard disk failure based on SMART data. The flowchart of the method is shown in FIG. 1, which includes the following steps of: 101, establishing a cloud storage server to continuously collect all types of data; 102, performing the normalization processing on the collected SMART parameter data and the corresponding hard disk brand and model data to generate a normalized SMART data set, and establishing a dynamic model for hard disk failure early warning based on the normalized SMART data set, the normalized SMART data set and the collected hard disk error log data; 103, grouping the collected SMART data into parameter groups, and combining the parameter groups with the corresponding hard disk brand and model data to form the dynamic change curves of SMART parameters of different brands and different models of hard disks, obtaining statistically the normal fluctuation range of SMART parameters for healthy operation of hard disks, and establishing the normal fluctuation curve and range of SMART parameters; 104, combining big data analytics with the SMART early warning parameter settings to obtain a health diagnosis score dynamic model; 105, starting health diagnosis; 106, determining the type of hard disk: a solid-state hard disk or a mechanical hard disk; 107, performing a diagnosis. The method only performs service life prediction modeling and prediction based on SMART state data information, the SMART method is simple and practical, but in practical application, if the reliability of the failure prediction model is reflected only by relying on the two indicators of the accuracy and the misjudgment rate, it is impossible to full identify the health of the hard disk, and unable to provide a clear early warning indication, which is insufficient to provide accurate prediction prompts to users, thereby failing to play an active role in protecting the security of a hard disk array or a storage system.

### SUMMARY

The present disclosure aims to provide a hard disk failure prediction method, a hard disk failure prediction system, a device and a medium, so as to solve the problem of low prediction accuracy of the hard disk failure prediction method in the prior art.

In order to achieve the above-mentioned purpose, the present disclosure provides the following solution.

A hard disk failure prediction method is provided, which includes:
acquiring Self-Monitoring Analysis and Reporting Technology (SMART) attribute values of a hard disk, a rating value of the SMART attribute values and a warning value of the SMART attribute values;
performing data standardization processing on the SMART attribute values to obtain processed SMART attribute values;
filtering the processed SMART attribute values by using a Relief algorithm to obtain filtered SMART attribute values;
constructing a hard disk failure prediction key database according to the filtered SMART attribute values, a warning value corresponding to the filtered SMART attribute values and a rating value corresponding to the filtered SMART attribute values;
optimizing a decision tree-based hard disk failure prediction model by using the hard disk failure prediction key database to obtain an optimized decision tree-based hard disk failure prediction model; and
acquiring SMART attribute values of a target hard disk, and predicting a health of the target hard disk by using the optimized decision tree-based hard disk failure prediction model to obtain a prediction result, wherein the prediction result is that the target hard disk is normal, the health of the target hard disk is poor or the target hard disk is about to fail.

In some embodiments, the performing data standardization processing on the SMART attribute values to obtain processed SMART attribute values specifically includes:
performing the data standardization processing on the SMART attribute values by using a formula

$${x}_{n o r} = 2 \times \frac{x - {x}_{min}}{{x}_{max} - {x}_{min}} - 1$$

to obtain the processed SMART attribute values, where x is the SMART attribute values, xₘᵢₙ is a minimum value of the SMART attribute values, Xₘₐₓ is a maximum value of the SMART attribute values; and Xₙₒᵣ is the processed SMART attribute values.

In some embodiments, the acquiring SMART attribute values of a target hard disk, and predicting a health of the target hard disk by using the optimized decision tree-based hard disk failure prediction model to obtain a prediction result includes:
inputting the SMART attribute values of the target hard disk into the optimized decision tree-based hard disk failure prediction model, and determining whether the SMART attribute values of the target hard disk are within a predetermined range;
if the SMART attribute values of the target hard disk are within the predetermined range, determining that the target hard disk is normal;
if the SMART attribute values of the target hard disk are not within the predetermined range, determining whether ratios of the SMART attribute values of the target hard disk to the warning value are greater than a predetermined value;
if the ratios of the SMART attribute values of the target hard disk to the warning value are greater than the predetermined value, determining that the target hard disk is about to fail;
if the ratios of the SMART attribute values of the target hard disk to the warning value are not greater than the predetermined value, determining that the health of the target hard disk is poor.

In some embodiments, the inputting the SMART attribute values of the target hard disk into the optimized decision tree-based hard disk failure prediction model and determining whether the SMART attribute values of the target hard disk are within a predetermined range specifically includes:
sorting the SMART attribute values of the target hard disk in a descending order according to weights of the SMART attribute values of the target hard disk; when the weights of the SMART attribute values of the target hard disk are the same, sorting the SMART attribute values of the target hard disk in a descending order according to failure probability of the SMART attribute values of the target hard disk to obtain sorted SMART attribute values;
inputting the sorted SMART attribute values into the optimized decision tree-based hard disk failure prediction model in sequence; and
determining whether a current SMART attribute value is within the predetermined range in sequence.

A hard disk failure prediction system is provided, including:
a data acquiring module, configured to acquire Self-Monitoring Analysis and Reporting Technology (SMART) attribute values of a hard disk, a rating value of the SMART attribute values and a warning value of the SMART attribute values;
a preprocessing module, configured to perform data standardization processing on the SMART attribute values to obtain processed SMART attribute values;
a filtering module, configured to filter processed SMART attribute values by using a Relief algorithm to obtain filtered SMART attribute values;
a database constructing module, configured to construct a hard disk failure prediction key database according to the filtered SMART attribute values, a warning value corresponding to the filtered SMART attribute values and a rating value corresponding to the filtered SMART attribute values;
a model optimizing module, configured to optimize a decision tree-based hard disk failure prediction model by using the hard disk failure prediction key database to obtain an optimized decision tree-based hard disk failure prediction model; and
a predicting module, configured to acquire SMART attribute values of a target hard disk, and predict a health of the target hard disk by using the optimized decision tree-based hard disk failure prediction model to obtain a prediction result; wherein the prediction result is that the target hard disk is normal, the health of the target hard disk is poor or the target hard disk is about to fail.

An electronic device is provided, including a memory and a processor, wherein the memory is used for storing a computer program, and the processor runs the computer program to cause the electronic device to execute the hard disk failure prediction method described above.

A non-transitory computer-readable storage medium is provided, which has a computer program embodied therein, wherein the computer program, when executed by a processor, implements the hard disk failure prediction method described above.

According to the specific embodiments provided by the present disclosure, the present disclosure discloses the following technical effects.

The hard disk failure prediction method provided by the present disclosure includes: first, acquiring the SMART attribute values of the hard disk, and preprocessing the SMART attribute values by using a min-max data standardization method; then, extracting key data attribute categories from the SMART attribute values by using the Relief algorithm, and constructing a hard disk failure prediction key database; finally, training the decision tree-based hard disk failure prediction model by using the hard disk failure prediction key database, and applying the trained decision tree-based hard disk failure prediction model to the prediction of the health of the hard disk online. According to the present disclosure, the key SMART attribute categories affecting the health of the hard disk are extracted by using the Relief algorithm, so that the input data dimension of the decision tree is reduced, and the efficiency of training and application is improved. In addition, the SMART attribute values with an extremely low failure probability are filtered out, which improves the accuracy of failure prediction and reduces the misjudgment rate to the greatest extent simultaneously.

### BRIEF DESCRIPTION OF THE DRAWINGS

In order to illustrate the embodiments of the present disclosure or the technical solutions in the prior art more clearly, the accompanying drawings that need to be used in the embodiments will be briefly introduced hereinafter. Apparently, the accompanying drawings in the following description are only some embodiments of the present disclosure, for those ordinarily skilled in the art, other drawings may also be obtained according to these drawings without making creative efforts.

FIG. 1 is a flowchart of a method of dynamically diagnosing hard disk failure based on SMART data in the prior art.

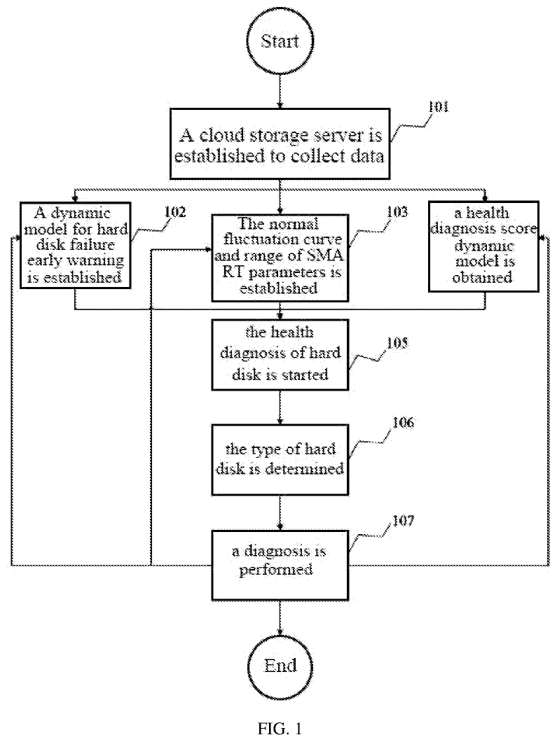

FIG. 2 is a flowchart of a hard disk failure prediction method according to the present disclosure.

FIG. 3 is a flowchart of a prediction of a decision tree-based hard disk failure prediction model in practical application according to the present disclosure.

### DETAILED DESCRIPTION OF THE EMBODIMENTS

The technical solutions in the embodiments of the present disclosure will be clearly and completely described with reference to the accompanying drawings in the embodiments of the present disclosure hereinafter. Apparently, the described embodiments are only some embodiments of the present disclosure, rather than all of the embodiments. Based on the embodiments in the present disclosure, all other embodiments obtained by those ordinarily skilled in the art without making creative efforts belong to the scope of protection of the present disclosure.

The present disclosure aims to provide a hard disk failure prediction method, a hard disk failure prediction system, a device and a medium, so as to solve the problem of low prediction accuracy of the hard disk failure prediction method in the prior art.

In order to make the above-mentioned purposes, features and advantages of the present disclosure more obvious and understandable, the present disclosure will be further described in detail below with reference to the accompanying drawings and specific embodiments.

### Embodiment 1

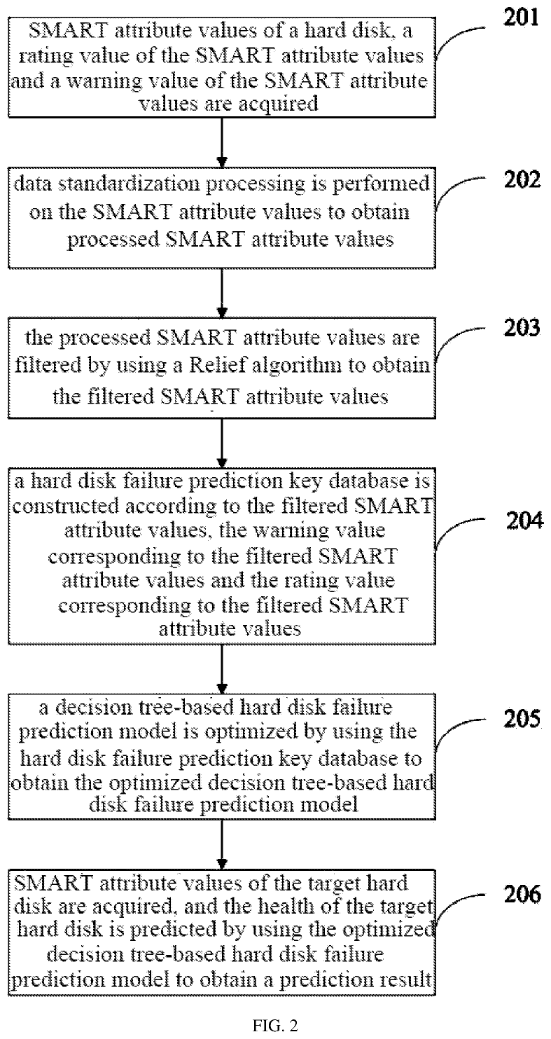

FIG. 2 is a flowchart of a hard disk failure prediction method according to the present disclosure. As shown in FIG. 2, the method includes the following steps 201 to 206.

In step 201, Self-Monitoring Analysis and Reporting Technology (SMART) attribute values of a hard disk, a rating value of the SMART attribute values and a warning value of the SMART attribute values are acquired. The SMART attribute values include the residual durability, the read error retry rate and the flight height of a magnetic head.

In step 202, data standardization processing is performed on the SMART attribute values to obtain processed SMART attribute values. In practical application, the SMART attribute values of the hard disk are preprocessed by using the min-max data standardization method.

In machine learning, data standardization is of great significance to its stability, so it is necessary to perform standardization processing on the data. The present disclosure adopts the min-max data standardization method to perform normalization processing on the SMART attribute values, that is, all the SMART attribute values are normalized into a [−1,1] region. The adopted formula for data standardization is as follows:

$${x}_{n o r} = 2 \times \frac{x - {x}_{min}}{{x}_{max} - {x}_{min}} - 1$$

where x is the SMART attribute values, xₘᵢₙ is a minimum value of the SMART attribute values, xₘₐₓ is a maximum value of the SMART attribute values, and xₙₒᵣ is the processed SMART attribute values. The standardized result (the processed SMART attribute values) xₙₒᵣ calculated through the formula is in the closed interval [−1,1], thereby achieving the purpose of standardizing the feature attribute values.

In step 203, the processed SMART attribute values are filtered by using a Relief algorithm to obtain the filtered SMART attribute values.

Due to the huge number of SMART attribute values of the hard disk, if all the SMART attribute values of the hard disk are inputted into the decision tree-based hard disk failure prediction model for prediction, a great pressure will be exerted on the decision tree-based hard disk failure prediction model and the CPU, so as to affect the normal operation of the computer. Therefore, before prediction, the Relief algorithm is adopted to filter the SMART attribute values, and the less important attribute values (such as motor operation) are filtered out to reduce the working pressure of the model and the CPU.

A sample hard disk A is randomly selected from all the hard disks used for training, and then the nearest neighbor sample hard disk B is found from the sample hard disks of the same brand as the sample hard disk A, which is called guessing the nearest neighbor; the nearest neighbor sample hard disk C is found from the sample hard disks of a different brand from the sample hard disk A, which is called guessing the neighbor wrongly.

If the distance between a certain attribute in the SMART attribute values of A and the attribute in the SMART attribute values of B is less than the distance between a certain attribute in the SMART attribute values of A and the attribute in the SMART attribute values of C, the weight of the attribute is increased; otherwise, the weight of the attribute is reduced.

The above process is repeated multiple times, and finally the average weight of each attribute in the SMART attribute values is obtained. The greater the weight of the attribute is, the stronger the classification ability of the attribute is, on the contrary, the weaker the classification ability of the attribute is. Therefore, it is necessary to eliminate the attribute values with weights lower than 0.05. The operating time of the Relief algorithm increases linearly with the number of sample samplings and the number of original attributes, so that the operating efficiency is very high.

In step 204, a hard disk failure prediction key database is constructed according to the filtered SMART attribute values, the warning value corresponding to the filtered SMART attribute values and the rating value corresponding to the filtered SMART attribute values.

After the filtering is completed, the remaining SMART attribute values (the remaining SMART attribute values refer to the SMART attribute values after the SMART attribute values with the weights lower than the predetermined value of 0.05 are eliminated) are constructed into a hard disk failure prediction key database, and the data in the database are divided into a training set and a test set according to the sequence of operating time of the hard disk.

In step 205, a decision tree-based hard disk failure prediction model is optimized by using the hard disk failure prediction key database to obtain the optimized decision tree-based hard disk failure prediction model.

Since different anomalous SMART attribute values lead to different probabilities of hard disk failure, it is necessary to divide the SMART attribute values by weighting according to the probability level of failure occurrence and the magnitude of damage to the hard disk caused by anomalous attribute values, so that the SMART attributes with a high weight are mainly predicted in the decision tree-based hard disk failure prediction model, thereby improving the failure prediction accuracy and ensuring the safe and stable operation of the hard disk.

Inputs include training data (including SMART attributes, difference attributes and target values), and the SMART attribute values after weights change, where a difference attribute refers to a ratio of a SMART attribute value to the warning value; and a target value refers to a rating value and a warning value of a SMART attribute value.

Output includes the optimized decision tree-based hard disk failure prediction model.

In order to evaluate the health of the hard disk more comprehensively, the model is optimized, and the SMART attribute values with a high weight are mainly predicted, while the prediction results are further divided.

Step 206: SMART attribute values of the target hard disk are acquired, and the health of the target hard disk is predicted by using the optimized decision tree-based hard disk failure prediction model to obtain a prediction result; wherein the prediction result is that the target hard disk is normal, the health of the target hard disk is poor or the target hard disk is about to fail.

If the SMART attribute values exceed the rated range (the predetermined range) and the ratios of the SMART attribute values to the warning value exceeds 0.5, it indicates that the hard disk is in an endangered state (about to fail) and may fail at any time, so that it is urgent to replace the hard disk; if the ratios of the SMART attribute values to the warning value do not exceed 0.5, it indicates that the hard disk starts to appear anomalous (poor health), which needs to be paid attention to. The hard disk may fail, but the probability of failure is low. It is decided whether to replace the hard disk in advance according to the user's own needs.

Further, the Step 206 specifically includes the following steps 2061 to 2065.

In step 2061, the SMART attribute values of the target hard disk are inputted into the optimized decision tree-based hard disk failure prediction model, to determine whether the SMART attribute values of the target hard disk are within a predetermined range.

In step 2062, if the SMART attribute values of the target hard disk are within the predetermined range, the target hard disk is determined to be normal.

In step 2063, if the SMART attribute values of the target hard disk are not within the predetermined range, it is determined whether the ratios of the SMART attribute values of the target hard disk to the warning value are greater than the predetermined value.

In step 2064, if the ratios of the SMART attribute values of the target hard disk to the warning value are greater than the predetermined value, the target hard disk is determined to be about to fail.

In step 2065, if the ratios of the SMART attribute values of the target hard disk to the warning value are not greater than the predetermined value, the health of the target hard disk is determined to be poor.

Specifically, the Step 2061 specifically includes:
sorting the SMART attribute values of the target hard disk in a descending order according to weights of the SMART attribute values of the target hard disk; sorting the SMART attribute values of the target hard disk in a descending order according to failure probability of the SMART attribute values of the target hard disk when the weights of the SMART attribute values of the target hard disk are the same, so as to obtain sorted SMART attribute values;
inputting the sorted SMART attribute values into the optimized decision tree-based hard disk failure prediction model in sequence; and
determining whether the current SMART attribute values are within the predetermined range in sequence.

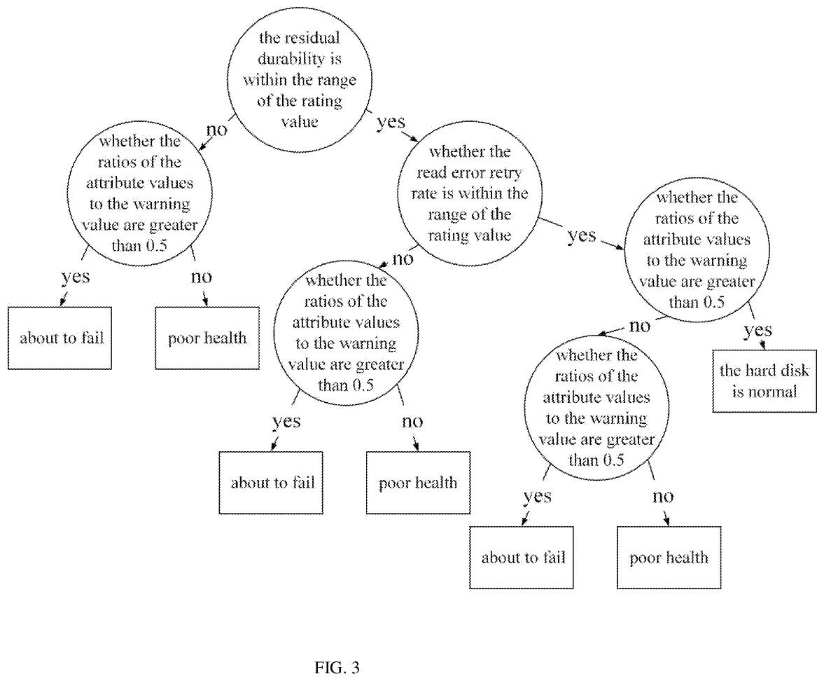

In practical application, as shown in FIG. 3, the prediction steps of the optimized decision tree-based hard disk failure prediction model are as follows.

(1) The SMART attribute values of the target hard disk in the hard disk failure prediction key database are sorted according to the weights, and the SMART attribute values with the same or similar weights are sorted in a descending order according to the likelihood of fault occurrence probability.

(2) The sorted data (the sorted SMART attribute values) are input into the optimized decision tree-based hard disk failure prediction model for prediction. Specifically, first, it is determined whether the SMART attribute values as data with the highest weight (for example, the residual durability) are within the range of the rating value.

A. If the data are not within the range of the rating value, it is necessary to further determine whether the ratios of the current SMART attribute values to the warning value are greater than 0.5. If the ratios are greater than 0.5, it indicates that the health of the hard disk is extremely poor, and the hard disk is about to fail, so that it is urgent to replace the hard disk. If the ratios are less than 0.5, it indicates that the health of the hard disk is poor, and it is necessary to observe the hard disk carefully and consider whether to replace the hard disk;

B. If the data are within the range of the rating value, the attribute value is normal, which will not result in hard disk failure.

(3) The SMART attribute values (such as the read error retry rate and the flight height of the magnetic head) with the next highest weight are determined, and the above-mentioned determination steps are repeated until all attribute values are determined. If all attribute values are normal, the health of the hard disk is good and no failure will occur.

In the present disclosure, first, a hard disk failure prediction key database is established, so that the working efficiency of the prediction model is improved, second, weights are allocated to the SMART attribute values according to the importance degree of the SMART attribute values in the database, so as to form a brand-new prediction model for hard disk failure prediction; compared with other machine learning models, on the premise of using the same data set, the accuracy of failure detection is improved, while the false positive rate is greatly reduced; compared with other existing schemes, the method has some advantages and provides a new solution to the problem of hard disk failure prediction.

Compared with the prior art, the present disclosure has the following advantages.

1. After acquiring the SMART attribute values of the hard disk, the data is normalized, the key data is filtered by using the Relief algorithm, and all the key data are stored to construct a hard disk failure prediction key database. Using this database for prediction may reduce the running pressure of the model and improve the prediction efficiency.

2. Weights are assigned to the SMART attribute values, and the attribute values with a high weight are mainly predicted to improve the prediction accuracy, simultaneously, the node division of the decision tree is further divided, and the prediction results are divided into three types: normal, poor health and about to fail, which represents the health status of the hard disk more comprehensively.

### Embodiment 2

In order to implement the method corresponding to above-mentioned Embodiment 1, the corresponding functions and technical effects may be achieved. A hard disk failure prediction system is provided hereinafter, including:
a data acquiring module, configured to acquire Self-Monitoring Analysis and Reporting Technology (SMART) attribute values of a hard disk, a rating value of the SMART attribute values and a warning value of the SMART attribute values;
a preprocessing module, configured to perform data standardization processing on the SMART attribute values to obtain processed SMART attribute values;
a filtering module, configured to filter the processed SMART attribute values by using a Relief algorithm to obtain filtered SMART attribute values;
a database constructing module, configured to construct a hard disk failure prediction key database according to the filtered SMART attribute values, a warning value corresponding to the filtered SMART attribute values and a rating value corresponding to the filtered SMART attribute values;
a model optimizing module, configured to optimize a decision tree-based hard disk failure prediction model by using the hard disk failure prediction key database to obtain an optimized decision tree-based hard disk failure prediction model; and
a predicting module, configured to acquire SMART attribute values of a target hard disk, and predict a health of the target hard disk by using the optimized decision tree-based hard disk failure prediction model to obtain a prediction result; wherein the prediction result is that the target hard disk is normal, the health of the target hard disk is poor or the target hard disk is about to fail.

### Embodiment 3

The present disclosure also provides an electronic device, including a memory

and a processor, wherein the memory is used for storing a computer program, and the processor runs the computer program to cause the electronic device to execute the hard disk failure prediction method according to Embodiment 1.

### Embodiment 4

The present disclosure also provides a non-transitory computer-readable storage medium, which has a computer program embodied therein, wherein the computer program, when executed by a processor, implements the hard disk failure prediction method according to Embodiment 1.

In this specification, various embodiments are described in a progressive way, the differences between each embodiment and other embodiments are highlighted, and the same and similar parts between various embodiments may be referred to each other. Because the system disclosed in the embodiment corresponds to the method disclosed in the embodiment, the system is described simply, and the relevant part may be referred to the description of the method part.

In the present disclosure, specific examples are applied to illustrate the principle and implementation of the present disclosure, and the explanations of the above-mentioned embodiments are only used to help understand the method and core ideas of the present disclosure. At the same time, according to the idea of the present disclosure, there are some changes in the specific implementation and application scope for those skilled in the art. To sum up, the contents of the specification should not be construed as limiting the present disclosure.

1-7. (canceled)

8. A hard disk failure prediction method, comprising:
acquiring Self-Monitoring Analysis and Reporting Technology (SMART) attribute values of a hard disk, a rating value of the SMART attribute values and a warning value of the SMART attribute values;
performing data standardization processing on the SMART attribute values to obtain processed SMART attribute values;
filtering the processed SMART attribute values by using a Relief algorithm to obtain filtered SMART attribute values;
constructing a hard disk failure prediction key database according to the filtered SMART attribute values, a warning value corresponding to the filtered SMART attribute values and a rating value corresponding to the filtered SMART attribute values;
optimizing a decision tree-based hard disk failure prediction model by using the hard disk failure prediction key database to obtain an optimized decision tree-based hard disk failure prediction model; and
acquiring SMART attribute values of a target hard disk, and predicting a health of the target hard disk by using the optimized decision tree-based hard disk failure prediction model to obtain a prediction result, wherein the prediction result is that the target hard disk is normal, the health of the target hard disk is poor or the target hard disk is about to fail.

9. The hard disk failure prediction method according to claim 8, wherein the performing data standardization processing on the SMART attribute values to obtain processed SMART attribute values specifically comprises:
performing the data standardization processing on the SMART attribute values by using a formula
$${x}_{n o r} = 2 \times \frac{x - {x}_{min}}{{x}_{max} - {x}_{min}} - 1$$
to obtain the processed SMART attribute values, wherein x is the SMART attribute values, xₘᵢₙ is a minimum value of the SMART attribute values, xₘₐₓ is a maximum value of the SMART attribute values; and xₙₒᵣ is the processed SMART attribute values.

10. The hard disk failure prediction method according to claim 8, wherein the acquiring SMART attribute values of a target hard disk, and predicting a health of the target hard disk by using the optimized decision tree-based hard disk failure prediction model to obtain a prediction result comprises:
inputting the SMART attribute values of the target hard disk into the optimized decision tree-based hard disk failure prediction model, and determining whether the SMART attribute values of the target hard disk are within a predetermined range;
if the SMART attribute values of the target hard disk are within the predetermined range, determining that the target hard disk is normal;
if the SMART attribute values of the target hard disk are not within the predetermined range, determining whether ratios of the SMART attribute values of the target hard disk to the warning value are greater than a predetermined value;
if the ratios of the SMART attribute values of the target hard disk to the warning value are greater than the predetermined value, determining that the target hard disk is about to fail;
if the ratios of the SMART attribute values of the target hard disk to the warning value are not greater than the predetermined value, determining that the health of the target hard disk is poor.

11. The hard disk failure prediction method according to claim 10, wherein the inputting the SMART attribute values of the target hard disk into the optimized decision tree-based hard disk failure prediction model and determining whether the SMART attribute values of the target hard disk are within a predetermined range specifically comprises:
sorting the SMART attribute values of the target hard disk in a descending order according to weights of the SMART attribute values of the target hard disk;
when the weights of the SMART attribute values of the target hard disk are the same, sorting the SMART attribute values of the target hard disk in a descending order according to failure probability of the SMART attribute values of the target hard disk to obtain sorted SMART attribute values;
inputting the sorted SMART attribute values into the optimized decision tree-based hard disk failure prediction model in sequence; and
determining whether a current SMART attribute value is within the predetermined range in sequence.

12. A hard disk failure prediction system, comprising:
a data acquiring module, configured to acquire Self-Monitoring Analysis and Reporting Technology (SMART) attribute values of a hard disk, a rating value of the SMART attribute values and a warning value of the SMART attribute values;
a preprocessing module, configured to perform data standardization processing on the SMART attribute values to obtain processed SMART attribute values;
a filtering module, configured to filter the processed SMART attribute values by using a Relief algorithm to obtain filtered SMART attribute values;
a database constructing module, configured to construct a hard disk failure prediction key database according to the filtered SMART attribute values, a warning value corresponding to the filtered SMART attribute values and a rating value corresponding to the filtered SMART attribute values;
a model optimizing module, configured to optimize a decision tree-based hard disk failure prediction model by using the hard disk failure prediction key database to obtain an optimized decision tree-based hard disk failure prediction model; and
a predicting module, configured to acquire SMART attribute values of a target hard disk, and predict a health of the target hard disk by using the optimized decision tree-based hard disk failure prediction model to obtain a prediction result, wherein the prediction result is that the target hard disk is normal, the health of the target hard disk is poor or the target hard disk is about to fail.

13. An electronic device, comprising a memory and a processor, wherein the memory is used for storing a computer program, and the processor runs the computer program to cause the electronic device to execute the hard disk failure prediction method according to claim 8.

14. The electronic device according to claim 13, wherein the performing data standardization processing on the SMART attribute values to obtain processed SMART attribute values specifically comprises:
performing the data standardization processing on the SMART attribute values by using a formula
$${x}_{n o r} = 2 \times \frac{x - {x}_{min}}{{x}_{max} - {x}_{min}} - 1$$
to obtain the processed SMART attribute values, wherein x is the SMART attribute values, xₘᵢₙ is a minimum value of the SMART attribute values, xₘₐₓ is a maximum value of the SMART attribute values; and xₙₒᵣ is the processed SMART attribute values.

15. The electronic device according to claim 13, wherein the acquiring SMART attribute values of a target hard disk, and predicting a health of the target hard disk by using the optimized decision tree-based hard disk failure prediction model to obtain a prediction result comprises:
inputting the SMART attribute values of the target hard disk into the optimized decision tree-based hard disk failure prediction model, and determining whether the SMART attribute values of the target hard disk are within a predetermined range;
if the SMART attribute values of the target hard disk are within the predetermined range, determining that the target hard disk is normal;
if the SMART attribute values of the target hard disk are not within the predetermined range, determining whether ratios of the SMART attribute values of the target hard disk to the warning value are greater than a predetermined value;
if the ratios of the SMART attribute values of the target hard disk to the warning value are greater than the predetermined value, determining that the target hard disk is about to fail;
if the ratios of the SMART attribute values of the target hard disk to the warning value are not greater than the predetermined value, determining that the health of the target hard disk is poor.

16. The electronic device according to claim 15, wherein the inputting the SMART attribute values of the target hard disk into the optimized decision tree-based hard disk failure prediction model and determining whether the SMART attribute values of the target hard disk are within a predetermined range specifically comprises:
sorting the SMART attribute values of the target hard disk in a descending order according to weights of the SMART attribute values of the target hard disk;
when the weights of the SMART attribute values of the target hard disk are the same, sorting the SMART attribute values of the target hard disk in a descending order according to failure probability of the SMART attribute values of the target hard disk to obtain sorted SMART attribute values;
inputting the sorted SMART attribute values into the optimized decision tree-based hard disk failure prediction model in sequence; and
determining whether a current SMART attribute value is within the predetermined range in sequence.

17. A non-transitory computer-readable storage medium which has a computer program embodied therein, wherein the computer program, when executed by a processor, implements the hard disk failure prediction method according to claim 8.

18. The non-transitory computer-readable storage medium according to claim 17, wherein the performing data standardization processing on the SMART attribute values to obtain processed SMART attribute values specifically comprises:
performing the data standardization processing on the SMART attribute values by using a formula
$${x}_{n o r} = 2 \times \frac{x - {x}_{min}}{{x}_{max} - {x}_{min}} - 1$$
to obtain the processed SMART attribute values, wherein x is the SMART attribute values, xₘᵢₙ is a minimum value of the SMART attribute values, xₘₐₓ is a maximum value of the SMART attribute values; and xₙₒᵣ is the processed SMART attribute values.

19. The non-transitory computer-readable storage medium according to claim 17, wherein the acquiring SMART attribute values of a target hard disk, and predicting a health of the target hard disk by using the optimized decision tree-based hard disk failure prediction model to obtain a prediction result comprises:
inputting the SMART attribute values of the target hard disk into the optimized decision tree-based hard disk failure prediction model, and determining whether the SMART attribute values of the target hard disk are within a predetermined range;
if the SMART attribute values of the target hard disk are within the predetermined range, determining that the target hard disk is normal;
if the SMART attribute values of the target hard disk are not within the predetermined range, determining whether ratios of the SMART attribute values of the target hard disk to the warning value are greater than a predetermined value;
if the ratios of the SMART attribute values of the target hard disk to the warning value are greater than the predetermined value, determining that the target hard disk is about to fail;
if the ratios of the SMART attribute values of the target hard disk to the warning value are not greater than the predetermined value, determining that the health of the target hard disk is poor.

20. The non-transitory computer-readable storage medium according to claim 19, wherein the inputting the SMART attribute values of the target hard disk into the optimized decision tree-based hard disk failure prediction model and determining whether the SMART attribute values of the target hard disk are within a predetermined range specifically comprises:
sorting the SMART attribute values of the target hard disk in a descending order according to weights of the SMART attribute values of the target hard disk;
when the weights of the SMART attribute values of the target hard disk are the same, sorting the SMART attribute values of the target hard disk in a descending order according to failure probability of the SMART attribute values of the target hard disk to obtain sorted SMART attribute values;
inputting the sorted SMART attribute values into the optimized decision tree-based hard disk failure prediction model in sequence; and
determining whether a current SMART attribute value is within the predetermined range in sequence.
